(19) United States
(12) Patent Application Publication
(10) Pub. No.: US 2020/0361249 A1
(43) Pub. Date: Nov. 19, 2020

(54) Pneumatic Tire

(71) Applicant: The Yokohama Rubber Co., LTD., Minato-ku, Tokyo (JP)

(72) Inventor: Masashi Tamura, Hiratsuka-shi, Kanagawa (JP)

(21) Appl. No.: 16/957,710

(22) PCT Filed: Dec. 7, 2018
(86) PCT No.: PCT/JP2018/045189

§ 371 Date: Jun. 24, 2020

(30) Foreign Application Priority Data
Dec. 25, 2017 (JP) 2017-247686

(51) Int. Cl. B60C 13/00; B60C 9/00

(52) U.S. Cl. CPC B60C 13/002; B60C 9/0042

(57) ABSTRACT

A pneumatic tire includes a tread portion; sidewall portions disposed on both sides of the tread portion; a pair of bead portions positioned inward of each of the sidewall portions in a tire radial direction; at least one layer of carcass spanning between the pair of bead portions; and an organic fiber reinforcement layer that is provided to at least one of the sidewall portions and is made of an organic fiber material are provided. The organic fiber reinforcement layer is provided closer to a tire outer surface than the carcass at a position within a range from 50% or greater to 90% or less of a tire cross-sectional height toward an outer side in a tire radial direction from an inner end portion of the bead portion in a tire radial direction.

### TECHNICAL FIELD

The present technology relates to a pneumatic tire.

### BACKGROUND ART

There has been a recent trend of reducing the thickness of components of pneumatic tires as much as possible without compromising the operational stability, strength, and the like, as an effort to achieve a lighter weight, smaller, rolling resistance, and the like. However, such a reduction in the thickness of tire components may lead to a lower cut resistance. The cut resistance is particularly likely to be compromised when a sidewall portion is thinned. This is because a sidewall portion has no strong reinforcement member, such as a belt layer provided to a tread portion. In view of this, some conventional pneumatic tires have improved cut resistance of the sidewall portion while suppressing increase in weight. For example, pneumatic tires described in Japan Patent Nos. 5680991 and 5680992 have the following configuration to improve cut resistance while enabling the weight reduction. Specifically, a sidewall portion is provided with a reinforcement member including a metal wire woven material.

A cut damage on a sidewall portion may largely expand when the sidewall portion or a tread portion is deflected during rotation of the pneumatic tire. This is particularly the case with a pneumatic tire used in a vehicle that travels on an unpaved road. Specifically, a sidewall portion of such a tire has a higher chance of coming into contact with a pebble or the like on the road on which the vehicle is traveling. Thus, a cut damage is likely to be formed on the sidewall portion. Furthermore, the pneumatic tire of such a vehicle receives a heavy load, meaning that the tread portion and the sidewall portion are likely to be largely deflected. Thus, the cut damage generated is likely to grow. Occurrence of such cut damages can be prevented to a certain level by measures such as providing a metal reinforce member to the sidewall portion as described in Patent Documents 1 and 2, or providing a protector such as protrusions to the sidewall portion. Unfortunately, once a cut damage is formed, it is extremely difficult to prevent it from growing.

In other words, there is a large difference in hardness between the metal reinforcing member provided to the sidewall portion and the rubber member forming the sidewall portion, leading to a larger stress of a rubber member due to deflection of the sidewall portion during the tire rotation. Thus, the cut damage is likely to grow largely. The growth of the cut damage may cause a separation between the reinforcement member and the rubber member. A further growth of the cut may even cause a separation between the rubber member and a carcass adjacent to the rubber member. Nevertheless, the growth of the cut is extremely difficult to inhibit with conventional solutions, such as a metal reinforcement member, for preventing the occurrence of the cut damage.

### SUMMARY

The present technology provides a pneumatic tire that can inhibit the growth of cut damage.

A pneumatic tire includes: a tread portion;

sidewall portions disposed on both sides of the tread portion; a pair of bead portions positioned inward of each of the sidewall portions in a tire radial direction; at least one layer of carcass spanning between the pair of bead portions; and an organic fiber reinforcement layer that is provided to at least one of the sidewall portions and is made of an organic fiber material, wherein the organic fiber reinforcement layer is provided closer to a tire outer surface than the carcass at a position within a range from 50% or greater to 90% or less of a tire cross-sectional height toward an outer side in a tire radial direction from an inner end portion of the bead portion in a tire radial direction.

In the pneumatic tire, the organic fiber reinforcement layer is preferably formed by layering a plurality of organic fiber reinforcement members made of the organic fiber material.

In the pneumatic tire, the organic fiber reinforcement members preferably include organic fiber cords made of the organic fiber material, and a relative angle θ between the respective organic fiber cords of adjacently stacked ones of the organic fiber reinforcement members is within a range of 15°≤θ≤165°.

In the pneumatic tire, in the organic fiber reinforcement layer, a distance Dr between end portions of adjacently stacked ones of the organic fiber reinforcement member is preferably within a range of 5 mm≤Dr≤20 mm.

In the pneumatic tire, an area Ai of a region surrounded by the organic fiber reinforcement layer and a tire inner surface and an area Ao of a region surrounded by the organic fiber reinforcement layer and the tire outer surface in a meridian cross-section preferably have relationship within a range of 0.5≤(Ai/Ao)≤1.5.

In the pneumatic tire, the tread portion is preferably provided with a belt layer,

the carcass includes a carcass main body spanning between the pair of bead portions, and turn-up portions that are continuously formed from the carcass main body and are tuned back from an inner side to an outer side in the tire lateral direction at the bead portions, wherein

the organic fiber reinforcement layer is separated from an end portion of the belt layer in the tire lateral direction by a distance Db satisfying Db≥10 mm and from an end portion of each of the turn-up portions of the carcass by a distance Dc satisfying Dc≥10 mm.

The pneumatic tire preferably further includes a stress relaxing rubber layer provided adjacent to the organic fiber reinforcement layer.

In the pneumatic tire, the sidewall portions preferably have a thickness of 30 mm or greater between the carcass and the tire outer surface.

A pneumatic tire according to embodiments of the present technology can achieve the effects of provide suppressing the growth of a cut damage.

### BRIEF DESCRIPTION OF DRAWINGS

FIG. 1 is a meridian cross-sectional view illustrating a main part of a pneumatic tire according to a first embodiment.

FIG. 2 is a detailed view of portion A of FIG. 1.

FIG. 3 is a schematic view of organic fiber cords of an organic fiber reinforcement member as viewed in a direction indicated by arrow B-B in FIG. 2.

FIG. 4 is a detail view of the part A of FIG. 1, and illustrates a region in a sidewall portion delimited by the organic fiber reinforcement layer serving as a boundary in a tire meridian cross-section.

FIG. 5 is a detail cross-sectional view of a main part of a pneumatic tire according to a second embodiment.

FIG. 6 is a diagram illustrating a modified example of the pneumatic tire according to the second embodiment where a stress relaxing rubber layer includes two layers.

FIG. 7A is a table showing the results of performance evaluation tests of pneumatic tires.

FIG. 7B is a table showing the results of performance evaluation tests of pneumatic tires.

### DETAILED DESCRIPTION

Pneumatic tires according to embodiments of the present technology are described in detail below with reference to the drawings. However, the present technology is not limited by the embodiment. Constituents of the following embodiments include elements that are essentially identical or that can be substituted or easily conceived by one skilled in the art.

### First Embodiment

Herein, “tire lateral direction” refers to the direction that is parallel with a rotation axis of a pneumatic tire. “Inward in the tire lateral direction” refers to the direction toward the tire equatorial plane in the tire lateral direction. “Outward in the tire lateral direction” refers to the direction opposite the direction toward the tire equatorial plane in the tire lateral direction. Furthermore, “tire radial direction” refers to the direction orthogonal to the tire rotation axis. “Inward in the tire radial direction” refers to the direction toward the tire rotation axis in the tire radial direction. “Outward in the tire radial direction” refers to the direction away from the tire rotation axis in the tire radial direction. “Tire circumferential direction” refers to the direction of rotation about the tire rotation axis. In the following description, “meridian direction” refers to a cross-section of the tire taken along a plane that includes the tire rotation axis.

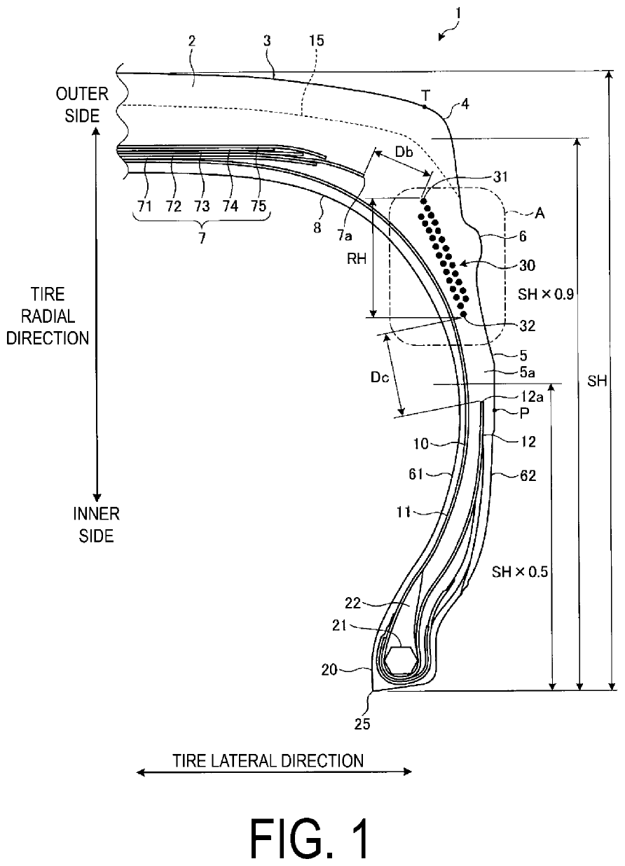

FIG. 1 is a meridian cross-sectional view illustrating a main part of a pneumatic tire 1 according to a first embodiment. The pneumatic tire 1 according to the first embodiment is a radial tire known as an Off the Road (OR) tire for a construction vehicle. The pneumatic tire 1 according to the first embodiment illustrated in FIG. 1, as viewed in a meridian cross-section, is provided with a tread portion 2 in the outermost portion in the tire radial direction. The surface of the tread portion 2, i.e., the portion that comes into contact with the road surface when a vehicle (not illustrated) mounted with the pneumatic tire 1 travels, is formed as a tread surface 3.

A plurality of lug grooves 15 is formed at a predetermined interval in the tire circumferential direction in the tread surface 3. A “lug groove 15” in a construction vehicle tire refers to a lateral groove having a groove width of 10 mm or greater, for example. The lug grooves 15 extend in the tire lateral direction and open to a tire ground contact edge T and open to tread edges on both sides in the tire lateral direction. The lug grooves 15 may extend parallel to the tire lateral direction, or may extend while being inclined with respect to the tire lateral direction. In the first embodiment, only the lug grooves 15 are formed in the tread surface 3, but circumferential grooves extending in the tire circumferential direction may be formed in the tread surface 3.

Note that “tread edge” refers to both end portions of a tread pattern portion of the tire. Furthermore, “tire ground contact edge T” refers to the maximum width position in the tire axial direction of the contact surface between the tire and a flat plate when the pneumatic tire 1 is mounted on a specified rim, inflated to the specified internal pressure, placed vertically on the flat plate in a static state, and loaded with a load corresponding to the specified load.

Here, “specified rim” refers to an “applicable rim” defined by the Japan Automobile Tyre Manufacturers Association (JATMA), a “Design Rim” defined by the Tire and Rim Association (TRA), or a “Measuring Rim” defined by the European Tyre and Rim Technical Organisation (ETRTO). Additionally, “specified internal pressure” refers to a “maximum air pressure” defined by JATMA, to the maximum value in “TIRE LOAD LIMITS AT VARIOUS COLD INFLATION PRESSURES” defined by TRA, and to “INFLATION PRESSURES” defined by ETRTO. Additionally, “specified load” refers to a “maximum load capacity” defined by JATMA, the maximum value in “TIRE LOAD LIMITS AT VARIOUS COLD INFLATION PRESSURES” defined by TRA, or “LOAD CAPACITY” defined by ETRTO.

The tread portion 2 has both ends in the tire lateral direction formed as shoulder portions 4. A sidewall portion 5 is provided between the shoulder portion 4 and inward of a predetermined position in the tire radial direction. Thus, the sidewall portions 5 are disposed on both sides of the tread portion 2 in the tire lateral direction and at two positions on both sides of the pneumatic tire 1 in the tire lateral direction. A protector 6 extending in the tire circumferential direction and protruding from the surface of the sidewall portion 5 is formed at a position, on the sidewall portion 5, close to the shoulder portion 4.

Furthermore, a bead portion 20 is located inward of each sidewall portion 5 in the tire radial direction. The bead portions 20 are disposed at two positions on both side of a tire equatorial plane (not illustrated) in a similar manner to that of the sidewall portions 5. Thus, a pair of the bead portions 20 is provided on both sides of the tire equatorial plane in the tire lateral direction. Note that this tire equatorial plane is a plane that passes through the center point of the pneumatic tire 1 in the tire lateral direction and is orthogonal to the tire rotation axis. The pair of bead portions 20 are each provided with a bead core 21, and a bead filler 22 is provided outward of each of the bead cores 21 in the tire radial direction. The bead core 21 is formed by winding a bead wire, which is a steel wire, into a ring shape. The bead filler 22 is a rubber material that is disposed in the space formed by an end portion of the carcass 10 in the tire lateral direction being folded back outward in the tire lateral direction, at the position of the bead core 21.

The bead portion 20 is configured to be mountable on a rim wheel with a specified rim tapered by 5°. Specifically, the pneumatic tire 1 according to the first embodiment can be mounted on a specified rim having a portion that mates with the bead portion 20 being inclined outward in the tire radial direction form the inner side toward the outer side in the tire lateral direction, by an inclination angle of 5°±1°.

A belt layers 7 is provided inward of the tread portion 2 in the tire radial direction. The belt layer 7 has a multilayer structure in which three or more belt plies are layered. In a typical OR tire, four to eight belt plies are layered. In the first embodiment, the belt layer 7 includes five belt plies 71, 72, 73, 74, and 75 that are layered. The belt plies 71, 72, 73, 74, and 75 thus forming the belt layer 7 are formed performing a rolling process on the resultant on a plurality of coating rubber-covered belt cords made of steel. Furthermore, at least a part of adjacently layered ones of the belt plies 71, 72, 73, 74, and 75 have different set inclination angles of the tire lateral direction of the belt cords with respect to the tire circumferential direction, and the belt plies are layered so that the inclination directions of the belt cords intersect each other, i.e., a crossply structure. Thus, the structural strength of the belt layer 7 is increased.

A carcass 10 is provided in a continuous manner inward of the belt layer 7 in the tire radial direction and on the tire equatorial plane side of the sidewall portion 5. The carcass 10 has a single layer structure made of one carcass ply or a multilayer structure made of a plurality of carcass plies, and extends between the bead cores 21 on both side in the tire lateral direction in a toroidal shape, forming the framework of the tire. In the first embodiment, the carcass 10 is a single carcass 10 including a single carcass ply.

Furthermore, the carcass 10 spans between the pair of bead portions 20. Specifically, the carcass 10 is disposed from one of the bead portions 20 to the other bead portion 20 of the pair of bead portions 20 located on both sides in the tire lateral direction, and turns back outward in the tire lateral direction along the bead cores 21 at the bead portions 20, wrapping around the bead cores 21 and the bead fillers 22. Thus, the carcass 10 includes a carcass main body portion 11 spanning between the pair of bead portions 20, and a turn-up portion 12 formed continuously from the carcass main body portion 11 and turned back at the bead core 21 of the bead portion 20 outward in the tire lateral direction from the inward side in the tire lateral direction.

This carcass main body 11 is a portion formed between inward sides of the pair of bead cores 21 in the tire lateral direction in the carcass 10. Turn-up portion 12 is a portion continuously formed from the carcass main body 11 on the inward side of the bead core 21 in the tire lateral direction, extends on the inward side of the bead core 21 in the tire radial direction, and is turned back outward in the tire lateral direction. The carcass ply (plies) of the carcass 10 thus provided is made by performing a rolling process on coating rubber-covered carcass cords made of steel. The carcass ply (plies) has a carcass angle, i.e., an inclination angle of the carcass cords with respect to the tire circumferential direction ranging from 85° to 95°. The turn-up portion 12 is formed to have a height in the tire radial direction, between the inner end portion 25 of the bead portion 20 in the tire radial direction and an outward end portion 12a of the turn-up portion 12 in the tire radial direction, in a range from 35% or greater to 65% of less of a tire cross-sectional height SH.

Additionally, an innerliner 8 is formed along the carcass 10 on the inner side of the carcass 10 or on the inner side of the carcass 10 in the pneumatic tire 1. The surface of the innerliner 8 opposite to the carcass 10 serves as a tire inner surface 61, which is the inner surface of the pneumatic tire 1. The sidewall portion 5 has a thickness of 30 mm or greater from the carcass main body 11 to a tire outer surface 62. The tire outer surface 62 is a surface on the outer side of the pneumatic tire 1, and is a surface of the pneumatic tire 1 on the side exposed to the outside air.

Furthermore, an organic fiber reinforcement layer 30 made of an organic fiber material such as aramid, nylon, polyester, rayon, or the like is disposed on at least one of the sidewall portions 5 disposed on both sides in the tire lateral direction. The organic fiber reinforcement layer 30 disposed on the sidewall portion 5 is disposed to be covered by a side rubber member 5a, which is the rubber composition forming the sidewall portion 5, and is formed outward of a tire maximum lateral position P of the pneumatic tire 1 in the tire radial direction. This tire maximum lateral position P is a position in the tire radial direction corresponding a position, excluding any structure protruding from the surface of the sidewall portion 5, achieving the longest length in the tire lateral direction, in the unloaded state with the pneumatic tire 1 mounted on the regular rim described above, inflated to the regular internal pressure described above, and receiving no load.

More specifically, the organic fiber reinforcement layer 30 is disposed closer to tire outer surface 62 than the carcass 10 is, at a position within a range from 50% or greater to 90% or less of the tire cross-sectional height SH toward the outer side in the tire radial direction from the inner end portion 25 of the bead portion 20 in the tire radial direction. At this position, the layer is disposed entirely over the tire circumferential direction. A height RH of the organic fiber reinforcement layer 30 is within a range of 0.1≤(RH/SH)≤0.4 with respect to the tire cross-sectional height SH. Thus, a position of a part of the organic fiber reinforcement layer 30 in the tire radial direction is the same as the position of the protector 6, formed in the sidewall portion 5, in the tire radial direction. The organic fiber reinforcement layer 30 is preferably disposed close to the center of the sidewall portion 5 in the thickness direction, and is preferably disposed to be embedded in the sidewall portion 5 while being separated from the tire outer surface 62 toward the tire inner surface 61 side by 10 mm or more.

The organic fiber reinforcement layer 30 is disposed at a position where a distance Db to an end portion 7a of the belt layer 7 in the tire lateral direction satisfies Db≥10 mm and a distance Dc to the outward end portion 12a of the turn-up portion 12 of the carcass 10 in the tire radial direction satisfies Dc≥10 mm Thus, the organic fiber reinforcement layer 30 is positioned with the distance Db between the end portion 7a of the belt layer 7 and the outer end portion 31 that is an end portion on the outward in the tire radial direction being 10 mm or greater, and with the distance Dc between the end portion 12a of the turn-up portion 12 and the inner end portion 32 that is the end portion in the inward in the tire radial direction being 10 mm or greater. In this case, the end portion 7a of the belt layer 7 is the end portion of the belt ply 72 that is the widest in the tire lateral direction among the plurality of belt plies 71, 72, 73, 74, and 75 of the belt layer 7. The distance Db between the outer end portion 31 of the organic fiber reinforcement layer 30 and the end portion 7a of the belt layer 7 and the distance Dc between the inner end portion 32 of the organic fiber reinforcement layer 30 and the end portion 12a of the turn-up portion 12 are each preferably 20 mm or greater.

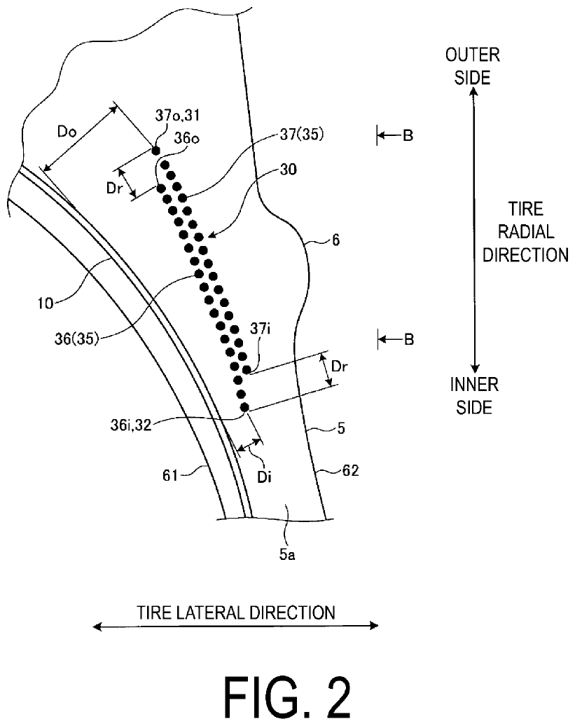

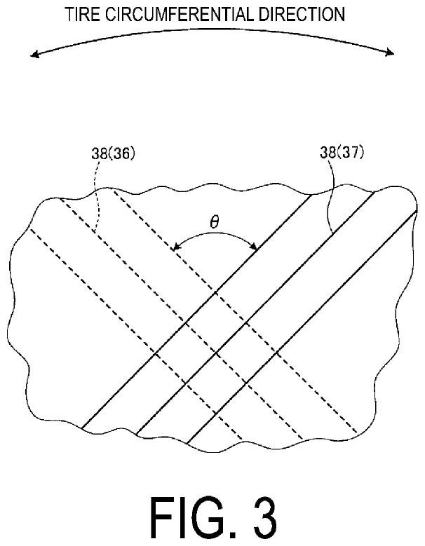

FIG. 2 is a detailed view of portion A of FIG. 1. FIG. 3 is a schematic view of organic fiber cords 38 of the organic fiber reinforcement members 35 as viewed in a direction indicated by arrow B-B in FIG. 2. The organic fiber reinforcement layer 30 is formed by layering a plurality of organic fiber reinforcement members 35 made of an organic fiber material. In the first embodiment, two organic fiber reinforcement members 35 including the first organic fiber reinforcement member 36 and the second organic fiber reinforcement member 37 are provided as the organic fiber reinforcement member 35. The organic fiber reinforcement layer 30 is formed by layering the first organic fiber reinforcement member 36 and the second organic fiber reinforcement member 37. For example, the two organic fiber reinforcement members 35 are layered with the first organic fiber reinforcement member 36 provided on the tire inner surface 61 side, and the second organic fiber reinforcement member 37 provided on the tire outer surface 62 side.

The organic fiber reinforcement member 35 forming the organic fiber reinforcement layer 30 includes the organic fiber cord 38 made of an organic fiber material such as aramid, nylon, polyester, and rayon, and is formed by arranging the plurality of coating-rubber covered organic fiber cords 38 side by side. The organic fiber cord 38 has a cord diameter (diameter of the cord) within a range from 0.3 mm or greater to 3.0 mm or less. The number of cords provided per 50 mm in the cord arrangement direction is within a range from 10 or more to 60 or less.

The organic fiber reinforcement members 35 adjacently layered have the organic fiber cords 38 of the respective organic fiber reinforcement members 35 crossing each other. Specifically, the first organic fiber reinforcement member 36 and the second organic fiber reinforcement member 37 have the organic fiber cord 38 of the first organic fiber reinforcement member 36 and the organic fiber cord 38 of the second organic fiber reinforcement member 37 crossing each other, with a relative angle θ between the organic fiber cords 38 being within a range of 15°≤θ≤165°.

The relative angle θ between the respective organic fiber cords 38 of the respective organic fiber reinforcement members 35 of the organic fiber reinforcement members 35 adjacently layered is within a range of 60°≤θ≤130°.

The two organic fiber reinforcement members 35 have the same height in the tire radial direction, that is, the same width in the tire radial direction.

Meanwhile, the two organic fiber reinforcement members 35 are layered with positions in the tire radial direction shifted from each other, that is, layered to be in positional relationship in which the first organic fiber reinforcement member 36 is shifted inward in the tire radial direction relative to the second organic fiber reinforcement member 37.

Specifically, in the organic fiber reinforcement layer 30, a distance Dr between the end portions of the adjacently layered organic fiber reinforcement members 35 is within a range of 5 mm≤Dr≤20 mm. In other words, a displacement amount Dr between the organic fiber reinforcement member 35 adjacently layered is within a range of 5 mm≤Dr≤20 mm. Thus, in the organic fiber reinforcement layer 30, the distance Dr between an outer end portion 36o of the first organic fiber reinforcement member 36 in the tire radial direction and an outer end portion 37o of the second organic fiber reinforcement member 37 in the tire radial direction, and the distance Dr between an inner end portion 36i of the first organic fiber reinforcement member 36 in the tire radial direction and an inner end portion 37i of the second organic fiber reinforcement member 37 in the tire radial direction are each within a range of 5 mm≤Dr≤20 mm.

Preferably, the distance Dr between the end portions of the organic fiber reinforcement members 35 adjacently layered is preferably within a range of 10 mm≤Dr≤15 mm.

In this manner, the two organic fiber reinforcement members 35 are layered while being shifted from each other in the tire radial direction. Thus, the tire radial direction outer end portion 37o of the second organic fiber reinforcement member 37 serves as the outer end portion 31 of the organic fiber reinforcement layer 30, and the inner end portion 36i of the first organic fiber reinforcement member 36 in the tire radial direction serves as the inner end portion 32 of the organic fiber reinforcement layer 30.

The organic fiber reinforcement layer 30 disposed more on the tire outer surface 62 side than the carcass 10 is inclined with respect to the carcass 10 so that the distance to the carcass 10 increases toward the outer end portion 31 from the inner end portion 32 that is closest to the carcass 10. The inner end portion 32 that is a portion of the organic fiber reinforcement layer 30 closest to the carcass 10 as described above is separated from the carcass 10 by a distance Di that is 5 mm or greater. Thus, the minimum distance between the organic fiber reinforcement layer 30 and the carcass 10 is 5 mm or greater. The outer end portion 31 which is the portion of the organic fiber reinforcement layer 30 farthest from the carcass 10 is separated from the carcass 10 by a distance Do that is 15 mm or greater.

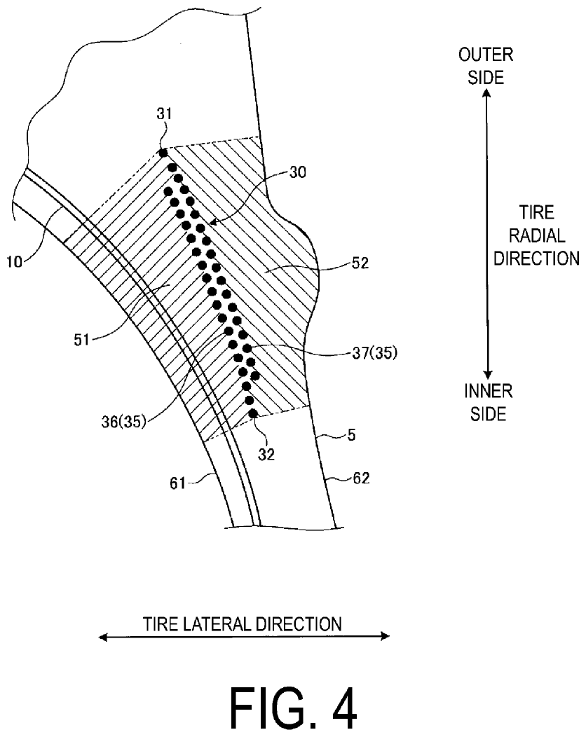

FIG. 4 is a detail view of the part A of FIG. 1, and illustrates a region in the sidewall portion 5 with the organic fiber reinforcement layer 30 serving as a boundary in the tire meridian cross-section. The sidewall portion 5 provided with the organic fiber reinforcement layer 30 has an area Ai of a region 51 surrounded by the organic fiber reinforcement layer 30 and the tire inner surface 61 in the meridian cross-section of the pneumatic tire 1 and an area Ao of a region 52 surrounded by the organic fiber reinforcement layer 30 and the tire outer surface 62 satisfying relationship 0.5≤(Ai/Ao)≤1.5. In this case, the region 51 surrounded by the organic fiber reinforcement layer 30 and the tire inner surface 61 is a region defined by the organic fiber reinforcement layer 30, the tire inner surface 61, and respective virtual lines extending orthogonal to the tire inner surface 61 from the outer end portion 31 and the inner end portion 32 of the organic fiber reinforcement layer 30. Similarly, the region 52 surrounded by the organic fiber reinforcement layer 30 and the tire outer surface 62 is a region defined by the organic fiber reinforcement layer 30, the tire outer surface 62, and respective virtual lines extending orthogonal to the tire outer surface 62 from the outer end portion 31 and the inner end portion 32 of the organic fiber reinforcement layer 30.

When the pneumatic tire 1 according to the first embodiment is mounted on a vehicle, first of all, the bead portion 20 is mated with a rim wheel having the regular rim so that the pneumatic tire 1 is mounted on the regular rim, and then the pneumatic tire 1 is mounted on the rim wheel. The pneumatic tire 1 mounted on the rim is inflated, and the pneumatic tire 1 on the rim and inflated is mounted on the vehicle. The pneumatic tire 1 according to the first embodiment, for example, is used as a construction vehicle pneumatic tire 1 worn on a construction vehicle such as a wheel loader.

When the vehicle on which the pneumatic tire 1 is mounted is driven, the pneumatic tire 1 rotates with the portion of the tread surface 3 located at the bottom being in contact with the road surface. The vehicle travels with driving force and braking force transmitted to the road surface, and turning force generated based on the frictional force between the tread surface 3 and the road surface. For example, when the driving force is transmitted to the road surface, power generated by a prime mover of the vehicle such as an engine is transmitted to the rim wheel, to be transmitted to the pneumatic tire 1 from the rim wheel.

The vehicle to which the pneumatic tire 1 according to the first embodiment is mounted is a construction vehicle, and thus travels on a road surface with pebbles, rocks, and the like scattered thereon. Thus, the pebble or the like on the road surface may come into contact with a portion of the pneumatic tire 1 other than the tread surface 3, while the vehicle is traveling. Specifically, the pebble or the like on the road surface coming into contact with the portion other than the tread surface 3, is likely to come into contact with a position of the sidewall portion 5 on the tread portion 2 side, which is a portion of the sidewall portion 5 relatively close to the tread surface 3.

The pebble or the like is harder than the side rubber member 5a. Thus, when the pebble or the like comes into contact with the sidewall portion 5 with large force, the pebble or the like may form a crack on the sidewall portion 5, and thus what is known as a cut damage which is a crack on the sidewall portion 5 may be formed. When the cut damage gets deep, the pebble or the like may come into contact with the carcass 10 provided inside the sidewall portion 5 to damage the carcass 10.

To prevent failure such as a damage on the carcass 10 due to such a cut damage, the pneumatic tire 1 according to the first embodiment is provided with the protector 6 formed on the sidewall portion 5. Specifically, the pebble or the like that comes into contact with the sidewall portion 5 come into contact with the protector 6. The protector 6 is formed to protrude from the tire outer surface 62 in the sidewall portion 5, thus the pebble or the like to come into contact with the sidewall portion 5 is likely to come into contact with the protector 6. Furthermore, the pebble or the like that has come into contact with the protector 6 is less likely to come into contact with a portion of the sidewall portion 5 other than the protector 6.

On the other hand, a cut damage that is formed in the vicinity of the protector 6 in the sidewall portion 5 due to the pebble or the like coming into contact with the protector 6 with a large amount of force, may grow to reach the carcass 10. In such a case, separation between the side rubber member 5a and the carcass 10, forming the sidewall portion 5, may occur with the cut damage being the starting point. In view of this, the pneumatic tire 1 according to the first embodiment is provided with the organic fiber reinforcement layer 30 at the position in the sidewall portion 5 closer to the tire outer surface 62 than the carcass 10 is. Thus, the cut damage formed at a portion of the sidewall portion 5 close to the protector 6 is less likely to develop.

Specifically, while the vehicle is traveling, the pneumatic tire 1 receives loaded in various directions, and thus elastic deformation of the sidewall portion 5 repeatedly occurs. The cut damage formed in the sidewall portion 5 is likely to grow to have a longer length and a deeper depth due to the elastic deformation of the sidewall portion 5. Still, in a portion of the sidewall portion 5 close to the portion where the organic fiber reinforcement layer 30 is provided, the elastic deformation is suppressed by the organic fiber reinforcement layer 30. Specifically, in the sidewall portion 5, a large elastic deformation of the side rubber member 5a forming the sidewall portion 5 is suppressed due to the organic fiber reinforcement layer 30. The organic fiber reinforcement layer 30 is made of an organic fiber material and thus can be spontaneously deflected. Thus, a difference in rigidity between the side rubber member 5a and the organic fiber reinforcement layer 30 is relatively small. Thus, the separation can be prevented from occurring between the organic fiber reinforcement layer 30 and the side rubber member 5a, while suppressing a large elastic deformation of the side rubber member 5a. All things considered, the organic fiber reinforcement layer 30 can prevent the cut damage formed on the sidewall portion 5 from growing due to the elastic deformation of the sidewall portion 5.

Furthermore, the organic fiber reinforcement layer 30 is provided at a position within a range from 50% or greater to 90% or less of the tire cross-sectional height SH from the inner end portion 25 of the bead portion 20 toward the outer side in the tire radial direction, so that the growth of the cut damage can be effectively suppressed. Specifically, the position in the sidewall portion 5 that is lower than 50% of the tire cross-sectional height SH toward the outer side in the tire radial direction from the inner end portion 25 of the bead portion 20 is separated from the tread surface 3 by a large distance, and thus is largely separated from the road surface. Thus, the pebble or the like is less likely to come into contact with such a position, meaning that the cut damage is less likely to occur at such a position. On the other hand, a position more on the outer side in the tire radial direction than 90% of the tire cross-sectional height SH from the inner end portion 25 of the bead portion 20 is in a region of the tread portion 2. Thus, a cut damage formed at such a position is less likely to reach the carcass 10.

On the other hand, a pebble or the like is likely to come into contact with the sidewall portion 5 while the vehicle is traveling at a position within a range from 50% or greater to 90% or less of the tire cross-sectional height SH toward the outer side in the tire radial direction from the inner end portion 25 of the bead portion 20. Furthermore, at the position, a distance from the tire outer surface 62 to the carcass 10 is relatively short. Thus, when a cut damage is formed within the range, separation between the carcass 10 and the side rubber member 5a is likely to occur with the cut damage being the starting point. In the first embodiment, the organic fiber reinforcement layer 30 is provided in this range of the sidewall portion 5. Thus, large elastic deformation of the side rubber member 5a can be prevented at a position where a cut damage is likely to be formed or a failure due to cut damage is likely to occur. Thus, growth of the cut damage can be suppressed.

Furthermore, the height RH of the organic fiber reinforcement layer 30 in the tire radial direction and the tire cross-sectional height SH are in a range of 0.1≤(RH/SH)≤0.4, whereby the growing of the cut damage can be more reliably suppressed. Specifically, when the rate or the height RH of the organic fiber reinforcement layer 30 in the tire radial direction to the tire cross-sectional height SH is (RH/SH)≤0.1 the height RH of the organic fiber reinforcement layer 30 is too low, and thus the elastic deformation of the side rubber member 5a might be difficult to effectively suppress. When the rate of the height RH of the organic fiber reinforcement layer 30 in the tire radial direction to the tire cross-sectional height SH is (RH/SH)>0.4, the organic fiber reinforcement layer 30 is disposed over a wide range on the inner side in the tire radial direction. This may result in an excessively short distance between the organic fiber reinforcement layer 30 and the carcass 10. The rigidity differs between the organic fiber reinforcement layer 30 and the carcass 10. Thus, when the distance between the organic fiber reinforcement layer 30 and the carcass 10 is excessively small, a difference in a mode deformation, due to the deformation of sidewall portion 5, the between the organic fiber reinforcement layer 30 and the carcass 10 is difficult to absorb with the side rubber member 5a provided therebetween, and thus the portion might have a high possibility of occurrence of separation.

On the other hand, when the rate of the height RH of the organic fiber reinforcement layer 30 in the tire radial direction to the tire cross-sectional height SH is 0.1≤(RH/SH)≤0.4, the distance between the organic fiber reinforcement layer 30 and the carcass 10 can be prevented from being excessively short, and the elastic deformation of the side rubber member 5a can be effectively prevented by the organic fiber reinforcement layer 30. As a result, the separation can be suppressed with the growth of the cut damage more reliably suppressed.

The organic fiber reinforcement layer 30 is formed by layering the plurality of organic fiber reinforcement members 35. Thus, the relative movement between the layered organic fiber reinforcement members 35 is restricted, whereby the elastic deformation of the side rubber member 5a can be more reliably suppressed by the organic fiber reinforcement layer 30. As a result, the cut damage can be more reliably prevented from growing.

A relative angle θ between the organic fiber cords 38 of the respective organic fiber reinforcement members 35 adjacently layered is within a range of 15°≤θ≤165°. Thus, the elastic deformation of the side rubber member 5a can be more reliably suppressed by the organic fiber reinforcement layer 30. Specifically, when the relative angle θ between the organic fiber cords 38 is smaller than 15° or greater than 165°, the relative angles θ between the respective organic fiber cords 38 of the organic fiber reinforcement members 35 are too close to each other. Thus, even when the organic fiber reinforcement members 35 are layered relative movement therebetween might be difficult to regulate. In such a case, the elastic deformation of the side rubber member 5a might be difficult to effectively suppress by the organic fiber reinforcement layer 30.

On the other hand, when the relative angle θ between the respective organic fiber cords 38 of the organic fiber reinforcement members 35 adjacently layered is within a range of 15°≤θ≤165°, a sufficient relative angle θ between the respective organic fiber cords 38 of the organic fiber reinforcement members 35 layered can be guaranteed. Thus, the organic fiber reinforcement members 35 layered can more reliably prevent the relative movement with each other. Accordingly, the elastic deformation of the side rubber member 5a can be more reliably suppressed by the organic fiber reinforcement layer 30. As a result, the cut damage can be more reliably prevented from growing.

In the organic fiber reinforcement layer 30, the distance Dr between the end portions of the organic fiber reinforcement members 35 adjacently layered is within a range of 5 mm≤Dr≤20 mm. Thus, the elastic deformation of the side rubber member 5a can be more reliably suppressed by the organic fiber reinforcement layer 30. Specifically, when the distance Dr between the end portions of the organic fiber reinforcement members 35 layered is Dr<5 mm, the distance Dr between the end portions of the organic fiber reinforcement members 35 is too short. Thus, the stress is concentrated in the vicinity of the end portions of the organic fiber reinforcement member 35 when the sidewall portion 5 is deformed. This might lead to a high risk of separation between the organic fiber reinforcement member 35 and the side rubber member 5a. When the distance Dr between the end portions of the organic fiber reinforcement members 35 layered is Dr>20 mm, the organic fiber reinforcement members 35 have a large a non-overlapped range between the organic fiber reinforcement members 35. Thus, effect of restricting the movement between the organic fiber reinforcement members 35 by the organic fiber reinforcement members 35 might be compromised. In such a case, the elastic deformation of the side rubber member 5a might be difficult to effectively suppress by the organic fiber reinforcement layer 30.

On the other hand, when the distance Dr between the end portions of the organic fiber reinforcement members 35 layered is within a range of 5 mm≤Dr≤20 mm, the organic fiber reinforcement members 35 can restrict the relative movement therebetween with the separation between the organic fiber reinforcement member 35 and the side rubber member 5a suppressed. Thus, the elastic deformation of the side rubber member 5a can be more reliably suppressed. As a result, the cut damage can be more reliably prevented from growing.

The area Ai of the region 51 surrounded by the organic fiber reinforcement layer 30 and the tire inner surface 61 in the meridian cross-section and the area Ao of the region 52 surrounded by the organic fiber reinforcement layer 30 and the tire outer surface 62 have relationship within a range of 0.5≤(Ai/Ao)≤1.5. Thus, growing of the cut damage can be suppressed, and the generation of the separation as well as the damaging of the organic fiber reinforcement layer 30 can be suppressed. Specifically, when the area Ai of the region 51 surrounded by the organic fiber reinforcement layer 30 and the tire inner surface 61 in the meridian cross-section and the area Ao of the region 52 surrounded by the organic fiber reinforcement layer 30 and the tire outer surface 62 have relationship (Ai/Ao)<0.5, the distance between the organic fiber reinforcement layer 30 and the carcass 10 might be too short. In such a case, a difference in the mode of deformation, due to the deformation of the sidewall portion 5, between the organic fiber reinforcement layer 30 and the carcass 10 is difficult to absorb with the side rubber member 5a provided therebetween. This may result in a higher risk of occurrence of separation in this portion. When the area Ai of the region 51 surrounded by the organic fiber reinforcement layer 30 and the tire inner surface 61 in the meridian cross-section and the area Ao of the region 52 surrounded by the organic fiber reinforcement layer 30 and the tire outer surface 62 have relationship (Ai/Ao)>1.5, the organic fiber reinforcement layer 30 is too close to the tire outer surface 62, resulting in a risk of the cut damage formed on the sidewall portion 5 leading to a damage on the organic fiber reinforcement layer 30.

On the other hand, when the area Ai of the region 51 surrounded by the organic fiber reinforcement layer 30 and the tire inner surface 61 in the meridian cross-section and the area Ao of the region 52 surrounded by the organic fiber reinforcement layer 30 and the tire outer surface 62 have relationship within a range of 0.5≤(Ai/Ao)≤1.5, the organic fiber reinforcement layer 30 can be prevented from being too close to both the carcass 10 and the tire outer surface 62. As a result, the occurrence of separation and damage to the organic fiber reinforcement layer 30 can be suppressed, and the growth of a cut damage can be more reliably suppressed.

The distance Db from the organic fiber reinforcement layer 30 to the end portion 7a of the belt layer 7 in the tire lateral direction satisfies Db≥10 mm, and the distance Dc from the organic fiber reinforcement layer 30 to the end portion 12a of the turn-up portion 12 of the carcass 10 satisfies Dc≥10 mm. Thus, the separation can be prevented from occurring in the vicinity of the organic fiber reinforcement layer 30. Specifically, when the distance Db from the organic fiber reinforcement layer 30 to the end portion 7a of the belt layer 7 or the distance Dc from the organic fiber reinforcement layer 30 to the end portion 12a of the turn-up portion 12 is less than 10 mm, the organic fiber reinforcement layer 30 might be too close to the belt layer 7 or the turn-up portion 12. In such a case, a difference in the mode of deformation between the organic fiber reinforcement layer 30 due to the deformation of the sidewall portion 5 and the belt layer 7 and the turn-up portion 12 is difficult to absorb with the side rubber member 5a provided therebetween. This may result in a higher risk of occurrence of separation in this portion.

On the other hand, when the distance Db from the organic fiber reinforcement layer 30 to the end portion 7a of the belt layer 7 or the distance Dc from the organic fiber reinforcement layer 30 to the end portion 12a of the turn-up portion 12 is 10 mm or greater, the occurrence of separation between the organic fiber reinforcement layer 30 and the belt layer 7 or the turn-up portion 12 can be prevented. As a result, the organic fiber reinforcement layer 30 can suppress the formation of a cut damage, without compromising the durability.

The thickness of the sidewall portion 5 from the carcass 10 to the tire outer surface 62 is 30 mm or greater, and thus a cut damage formed on the tire outer surface 62 is less likely to reach the carcass 10. Thus, the occurrence of separation between the carcass 10 and the side rubber member 5a with the cut damage being the starting point can be suppressed. As a result, a failure due to a cut damage can be reduced, whereby durability can be improved.

### Second Embodiment

A pneumatic tire 1 according to a second embodiment has substantially the same configuration as the pneumatic tire 1 according to the first embodiment, except that it includes a stress relaxing rubber layer 40. The other configurations are the same as those in the first embodiment, and thus will be denoted with the same reference numerals and the description thereof will be omitted.

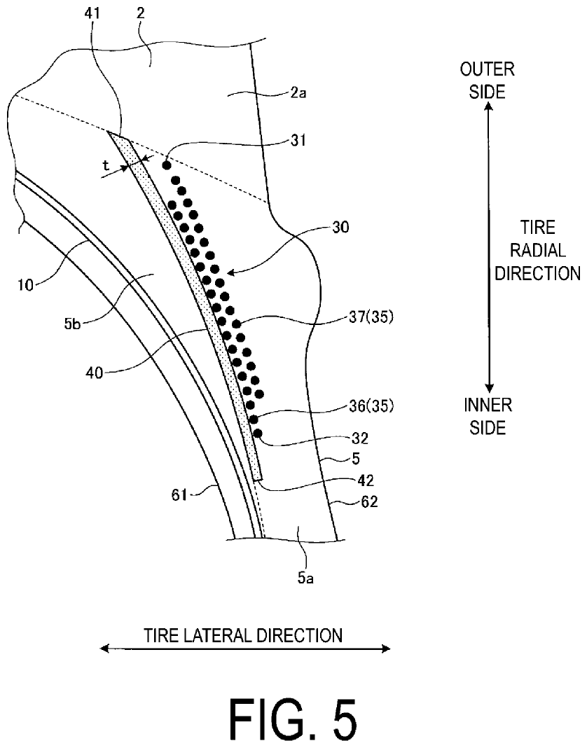

FIG. 5 is a detail view of a main part of the pneumatic tire 1 according to the second embodiment. The pneumatic tire 1 according to the second embodiment includes the organic fiber reinforcement layer 30, having the two organic fiber reinforcement member 35, provided to the sidewall portion 5 as in the pneumatic tire 1 according to the first embodiment. In the second embodiment, the sidewall portion 5 is further provided with the stress relaxing rubber layer 40 adjacent to the organic fiber reinforcement layer 30. The stress relaxing rubber layer 40 is provided more on the tire inner surface 61 side than the organic fiber reinforcement layer 30.

Specifically, in a region of the sidewall portion 5 close to the tread portion 2, a belt cushion rubber member 5b as a rubber composition is provided between the side rubber member 5a, forming the tire outer surface 62, and the carcass 10. In the region where the belt cushion rubber member 5b is provided, the carcass 10 is in contact with the belt cushion rubber member 5b. The outer end portions of the side rubber member 5a and the belt cushion rubber member 5b in the tire radial direction are connected to the tread rubber member 2a that is a rubber composition forming the tread portion 2.

The organic fiber reinforcement layer 30 is provided in a region of the sidewall portion 5 outward of the belt cushion rubber member 5b in the tire lateral direction, and inward of the position where the side rubber member 5a is connected to the tread rubber member 2a in the tire radial direction, and is embedded in the side rubber member 5a. The stress relaxing rubber layer 40 is provided more on the tire inner surface 61 side than the organic fiber reinforcement layer 30, and is provided adjacent to the belt cushion rubber member 5b. Thus, in the range where the organic fiber reinforcement layer 30 is provided, the stress relaxing rubber layer 40 has the surface on the tire outer surface 62 side provided adjacent to the organic fiber reinforcement layer 30 and has the surface on the tire inner surface 61 side provided adjacent to the belt cushion rubber member 5b. The stress relaxing rubber layer 40 thus provided between the organic fiber reinforcement layer 30 and the belt cushion rubber member 5b has a thickness t within a range of 3 mm≤t≤10 mm.

The stress relaxing rubber layer 40 has an outer end portion 41 in the tire radial direction extends to the position of the tread rubber member 2a while being positioned outward of the outer end portion 31 of the organic fiber reinforcement layer 30 in the tire radial direction, and has an inner end portion 42 in the tire radial direction positioned inward of the inner end portion 32 of the organic fiber reinforcement layer 30 in the tire radial direction. The outer end portion 41 of the stress relaxing rubber layer 40 is preferably separated outward in the tire radial direction from the outer end portion 31 of the organic fiber reinforcement layer 30 by a distance within a range from 10 mm or greater to 20 mm or less. The inner end portion 42 of the stress relaxing rubber layer 40 is preferably separated inward in the tire radial direction from the inner end portion 32 of the organic fiber reinforcement layer 30 by a distance within a range from 10 mm or greater to 20 mm or less.

The stress relaxing rubber layer 40 thus provided has a JIS (Japanese Industrial Standard)-A hardness that is lower than the JIS-A hardness of the belt cushion rubber member 5b. Specifically, the JIS-A hardness of the belt cushion rubber member 5b is within a range from 50 or greater to 70 or less, whereas the JIS-A hardness of the stress relaxing rubber layer 40 at 23° C. is within a range from 45 or greater to 60 or less. The JIS-A hardness of the side rubber member 5a is within a range from 45 or greater to 75 or less. The JIS-A hardness in this case is the durometer hardness measured in accordance with JIS K-6253 using a type A durometer and under a temperature of 23° C.

The pneumatic tire 1 according to the second embodiment includes the stress relaxing rubber layer 40 provided adjacent to the organic fiber reinforcement layer 30. Thus, occurrence of separation due to stress concentrating as a result of a difference in rigidity between the organic fiber reinforcement layer 30 and a member adjacent to the organic fiber reinforcement layer 30. As a result, the organic fiber reinforcement layer 30 can suppress the formation of a cut damage, without compromising the durability.

A member with a lower JIS-A hardness than the belt cushion rubber member 5b is used for the stress relaxing rubber layer 40, and the stress relaxing rubber layer 40 is provided between the organic fiber reinforcement layer 30 and the belt cushion rubber member 5b. Thus, an inner layer strain between the organic fiber reinforcement layer 30 and the belt cushion rubber member 5b can be more reliably reduced. Specifically, the stress relaxing rubber layer 40 has a lower JIS-A hardness than the belt cushion rubber member 5b. Thus, even when a mode of elastic deformation, due to the deformation of the sidewall portion 5, differs between the organic fiber reinforcement layer 30 and the belt cushion rubber member 5b, such a difference can be absorbed by the stress relaxing rubber layer 40. Thus, the concentration of stress due to a difference in rigidity between the organic fiber reinforcement layer 30 and the belt cushion rubber member 5b can be suppressed, whereby the inter layer strain can be reduced. Thus, the separation between the organic fiber reinforcement layer 30 and the belt cushion rubber member 5b can be suppressed. As a result, the organic fiber reinforcement layer 30 can suppress the formation of a cut damage more reliably, without compromising the durability.

### Modified Examples

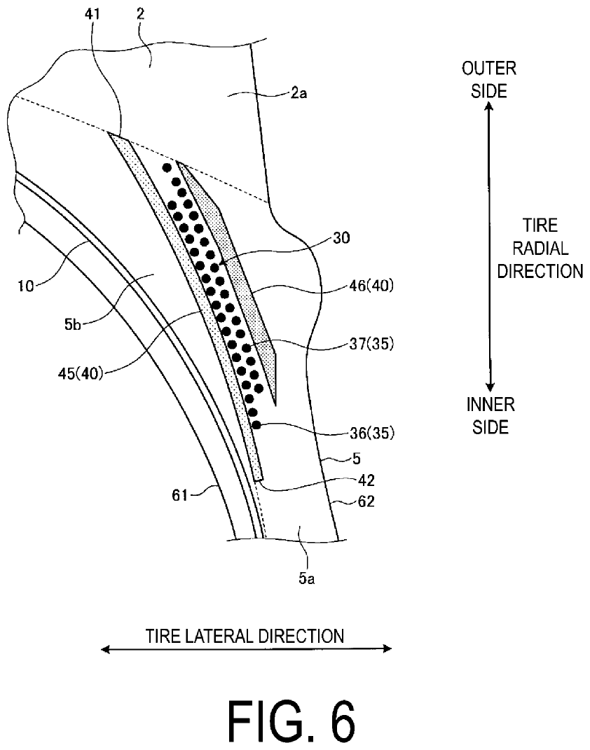

In the second embodiment described above, the stress relaxing rubber layer 40 is provided between the organic fiber reinforcement layer 30 and the belt cushion rubber member 5b. Alternatively, the stress relaxing rubber layer 40 can be provided at a location other than this. FIG. 6 is a diagram illustrating a modified example of the pneumatic tire 1 according to the second embodiment where the stress relaxing rubber layer 40 includes two layers. For example, the stress relaxing rubber layer 40 may include, for example illustrated in FIG. 6, an inward stress relaxing rubber layer 45 provided more on the tire inner surface 61 side than the organic fiber reinforcement layer 30 and an outward stress relaxing rubber layer 46 provided more on the tire outer surface 62 side than the organic fiber reinforcement layer 30. The organic fiber reinforcement layer 30 has rigidity also different from that of the side rubber member 5a. Thus, the mode of deformation, due to the elastic deformation of the sidewall portion 5, differs between the organic fiber reinforcement layer 30 and the side rubber member 5a. In view of this, by providing not only the inward stress relaxing rubber layer 45, but also providing the outward stress relaxing rubber layer 46, the inter layer strain between the organic fiber reinforcement layer 30 and the side rubber member 5a can be reduced. Thus, the separation between the organic fiber reinforcement layer 30 and the side rubber member 5a can be prevented, and degradation of the durability can be more reliably prevented.

The stress relaxing rubber layer 40 may also be provided between the organic fiber reinforcement members 35 layered. With the stress relaxing rubber layer 40 provided between the organic fiber reinforcement members 35, a difference between the organic fiber reinforcement layer 30 and a member adjacent to the organic fiber reinforcement layer 30 in rigidity can be at a tolerable level. Thus, with the organic fiber reinforcement layer 30, the occurrence of the separation can be prevented, and the side rubber member 5a can be prevented from largely deforming elastically. As a result, the organic fiber reinforcement layer 30 can suppress the formation of a cut damage, without compromising the durability.

In the second embodiment described above, the outer end portion 41 of the stress relaxing rubber layer 40 is connected to the tread rubber member 2a. Alternatively, the outer end portion 41 of the stress relaxing rubber layer 40 may not be connected to the tread rubber member 2a. The stress relaxing rubber layer 40 can be in any relationship with other members, as long as the end portion in the tire radial direction is separated from the end portion of the organic fiber reinforcement layer 30 in the tire radial direction by a distance within a range from 10 mm or greater to 20 mm or less.

In the first embodiment described above, the carcass 10 includes a single carcass ply, has steel used as a carcass cord, and has a carcass angle that is equal to or greater than 85° and equal to or smaller than 95°. Thus, what is known as a radial structure is employed. However, the carcass 10 may be formed in a mode other than this. For example, the carcass 10 may have a multi-layer structure with a plurality of carcass plies layered. In this case, the carcass plies are preferably formed to be in what is known as a bias structure by performing a rolling process on a plurality of coating-rubber covered carcass cords made of an organic fiber material such as aramid, nylon, polyester, and rayon, with an absolute value of the cord angle with respect to the tire circumferential direction set to be equal to or larger than 20° and equal to or small than 50°, and the carcass cords of the adjacent carcass plies being provided to intersect with each other.

When the carcass 10 is formed to have the bias structure, four or more carcass plies are preferably used. Furthermore, when the carcass 10 is formed to have the bias structure, the turn-up portion 12 is preferably formed to have a height in the tire radial direction, between the inner end portion 25 of the bead portion 20 in the tire radial direction and an outer end portion 12a of the turn-up portion 12 in the tire radial direction ranging from 35% or greater to 65% or less with respect to a tire cross-sectional height SH.

In the first and the second embodiments described above, the organic fiber reinforcement layer 30 is formed by layering the two organic fiber reinforcement members 35, that is, the first organic fiber reinforcement member 36 and the second organic fiber reinforcement member 37. Alternatively, the organic fiber reinforcement layer 30 may be formed by elements other than the two organic fiber reinforcement members 35. For example, the organic fiber reinforcement layer 30 may be formed by a single organic fiber reinforcement member 35 or may be formed by layering three or more organic fiber reinforcement members 35.

### Examples

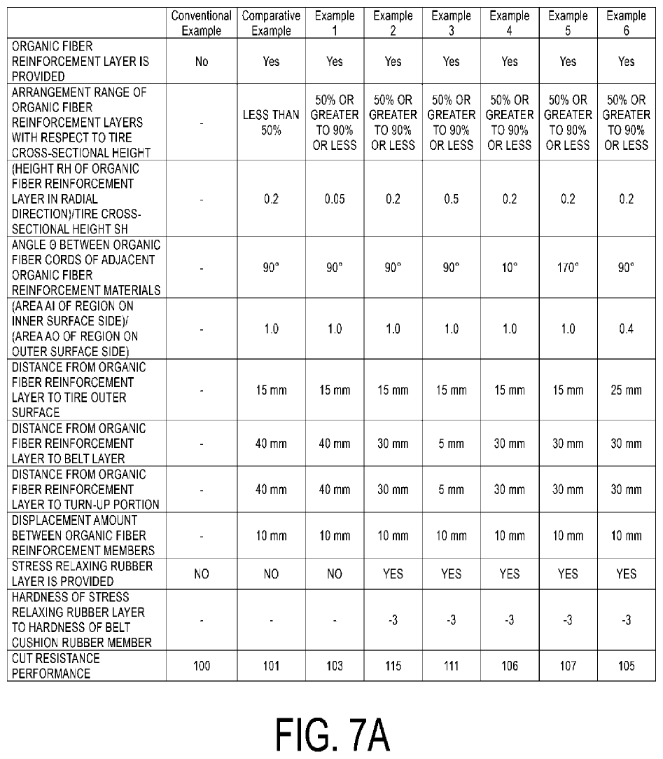

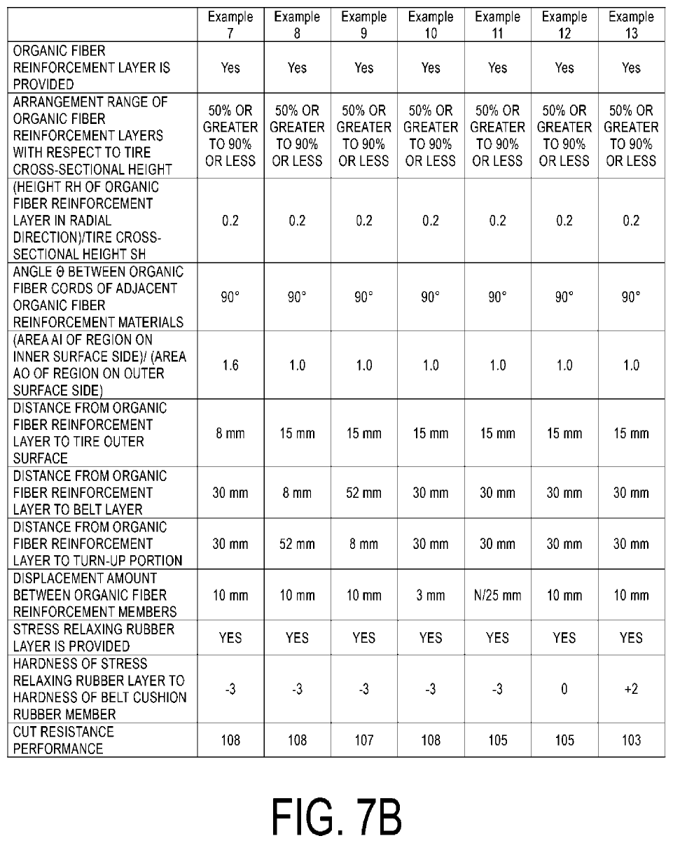

FIGS. 7A and 7B are tables showing the results of performance evaluation tests of pneumatic tires. In relation to the pneumatic tire 1 described above, performance evaluation tests conducted on a pneumatic tire according to Conventional Example, the pneumatic tire 1 according to embodiments of the present technology, and a pneumatic tire according Comparative Example to be compared with the pneumatic tire 1 according to embodiments o the present technology will be described below. As the performance evaluation test, a test for cut resistance performance indicating durability against cut damages was performed.

The performance evaluation test was performed through a test drive of dump truck used as a performance test vehicle wearing a pneumatic tire 1 having a nominal size of 29.5R25 as defined by JATMA mounted on a JATMA standard rim wheel having tire pressure adjusted to be 525 kPa. After an operation for 1000 hours on the test vehicle wearing the test tire, the cut resistance performance was evaluated by measuring the length and the depth of each cut damage formed on the sidewall portion 5. A reciprocal of a value obtained by multiplying the length by the depth was obtained as an index, with the reciprocal obtained with Conventional Example described later assigned the value of 100. A larger index value corresponds to a smaller spread of cut damage, and thus indicates a superior cut resistance performance.

The performance evaluation test was performed on 15 types of pneumatic tires including a pneumatic tire of Conventional Example that is one example of a conventional pneumatic tire, Examples 1 to 13 of the pneumatic tire 1 according to embodiments of the present technology, and Comparative Example corresponding to a pneumatic tire to be compared with the pneumatic tire 1 according to the present technology. Among these, the pneumatic tire of Conventional Example has no organic fiber reinforcement layer 30 provided to the sidewall portion 5. The pneumatic tire according to Comparative Example has the organic fiber reinforcement layer 30 provided to the sidewall portion 5, but the organic fiber reinforcement layer 30 is provided in a range that is less than 50% of the tire cross-sectional height SH toward the outer side in the tire radial direction from the inner end portion 25 of the bead portion 20.

On the other hand, Examples 1 to 13 of the pneumatic tire 1 according to embodiments of the present technology all had the organic fiber reinforcement layer 30 provided within a range from 50% or greater to 90% or less of the tire cross-sectional height SH toward the outer side in the tire radial direction from the inner end portion 25 of the bead portion 20. Furthermore, the pneumatic tire 1 according to Examples 1 to 13 are different from each other in the height RH (RH/SH) of the organic fiber reinforcement layer 30 in the tire radial direction relative to the tire cross-sectional height SH, the relative angle θ between the organic fiber cords 38 of the adjacent organic fiber reinforcement members 35, the relationship (Ai/Ao) between the area Ai of region 51 surrounded by the organic fiber reinforcement layer 30 and the tire inner surface 61 and the area Ao of the region 52 surrounded by the organic fiber reinforcement layer 30 and the tire outer surface 62, the distance from the organic fiber reinforcement layer 30 to the tire outer surface 62, the distance Db from the organic fiber reinforcement layer 30 to the belt layer 7, the distance Dc from the organic fiber reinforcement layer 30 to the turn-up portion 12 of the carcass 10, the displacement amount Dr between the organic fiber reinforcement members 35 adjacently layered, whether the stress relaxing rubber layer 40 is provided, and the hardness of the stress relaxing rubber layer 40 relative to the hardness of the belt cushion rubber member 5b.

Results of the performance evaluation test performed using these pneumatic tires 1, illustrated in FIG. 7A and FIG. 7B, indicate that the pneumatic tire 1 according to Examples 1 to 13 achieved higher cut resistance performance than Conventional Example and Comparative Example. Thus, the pneumatic tire 1 according to Examples 1 to 13 can prevent the cut damage from growing.

1. A pneumatic tire comprising:
a tread portion;
sidewall portions disposed on both sides of the tread portion;
a pair of bead portions positioned inward of each of the sidewall portions in a tire radial direction to be a pair of bead portions;
at least one layer of carcass spanning between the pair of bead portions; and
an organic fiber reinforcement layer that is provided to at least one of the sidewall portions and is made of an organic fiber material,
the organic fiber reinforcement layer being provided closer to a tire outer surface than the carcass at a position within a range from 50% or greater to 90% or less of a tire cross-sectional height toward an outer side in a tire radial direction from an inner end portion of the bead portion in a tire radial direction.

2. The pneumatic tire according to claim 1, wherein the organic fiber reinforcement layer is formed by layering a plurality of organic fiber reinforcement members made of the organic fiber material.

3. The pneumatic tire according to claim 2, wherein
the organic fiber reinforcement members include organic fiber cords made of the organic material, and
a relative angle θ between respective organic fiber cords of adjacently layered ones of the organic fiber reinforcement members is within a range of 15°≤θ≤165°.

4. The pneumatic tire according to claim 2, wherein in the organic fiber reinforcement layer, a distance Dr between end portions of adjacently layered ones of the organic fiber reinforcement member is within a range of 5 mm≤Dr≤20 mm.

5. The pneumatic tire according to claim 1, wherein an area Ai of a region surrounded by the organic fiber reinforcement layer and a tire inner surface and an area Ao of a region surrounded by the organic fiber reinforcement layer and the tire outer surface in a meridian cross-section have relationship within a range of 0.5≤(Ai/Ao)≤1.5.

6. The pneumatic tire according to claim 1, wherein
the tread portion is provided with a belt layer,
the carcass includes a carcass main body spanning between the pair of bead portions and turn-up portions that are continuously formed from the carcass main body and are tuned back from an inner side to an outer side in a tire lateral direction at the bead portions, wherein
the organic fiber reinforcement layer is separated from an end portion of the belt layer in the tire lateral direction by a distance Db satisfying Db≥10 mm and from an end portion of each of the turn-up portions of the carcass by a distance Dc satisfying Dc≥10 mm.

7. The pneumatic tire according to claim 1, further comprising a stress relaxing rubber layer provided adjacent to the organic fiber reinforcement layer.

8. The pneumatic tire according to claim 1, wherein the sidewall portions have a thickness of 30 mm or greater between the carcass and the tire outer surface.

9. The pneumatic tire according to claim 3, wherein in the organic fiber reinforcement layer, a distance Dr between end portions of adjacently layered ones of the organic fiber reinforcement member is within a range of 5 mm≤Dr≤20 mm.

10. The pneumatic tire according to claim 9, wherein an area Ai of a region surrounded by the organic fiber reinforcement layer and a tire inner surface and an area Ao of a region surrounded by the organic fiber reinforcement layer and the tire outer surface in a meridian cross-section have relationship within a range of 0.5≤(Ai/Ao)≤1.5.

11. The pneumatic tire according to claim 10, wherein
the tread portion is provided with a belt layer,
the carcass includes a carcass main body spanning between the pair of bead portions and turn-up portions that are continuously formed from the carcass main body and are tuned back from an inner side to an outer side in a tire lateral direction at the bead portions, wherein
the organic fiber reinforcement layer is separated from an end portion of the belt layer in the tire lateral direction by a distance Db satisfying Db≥10 mm and from an end portion of each of the turn-up portions of the carcass by a distance Dc satisfying Dc≥10 mm.

12. The pneumatic tire according to claim 11, further comprising a stress relaxing rubber layer provided adjacent to the organic fiber reinforcement layer.

13. The pneumatic tire according to claim 12, wherein the sidewall portions have a thickness of 30 mm or greater between the carcass and the tire outer surface.
